(19) United States
(12) Patent Application Publication
(10) Pub. No.: US 2015/0131400 A1
(43) Pub. Date: May 14, 2015

(54) KNEADING MACHINE

(71) Applicants: Atsushi Fujii, Osaka (JP); Koji Yamasaki, Osaka (JP); Kazunori Fukumoto, Osaka (JP)

(72) Inventors: Atsushi Fujii, Osaka (JP); Koji Yamasaki, Osaka (JP); Kazunori Fukumoto, Osaka (JP)

(21) Appl. No.: 14/404,958

(22) PCT Filed: Jun. 4, 2012
(86) PCT No.: PCT/JP2012/064367

§ 371 Date: Dec. 2, 2014

(51) Int. Cl. B01F 7/00

(52) U.S. Cl. CPC B01F 7/00975
USPC 366/84

(57) ABSTRACT

A two-shaft continuous kneading machine is disclosed wherein airtightness in a housing is assured by a simple means without using a mechanical seal. A magnetic coupling mechanism is formed between the mechanism in the housing (2) including shafts (3) of the kneading machine (1) and a carrier (5) arranged outside the housing (2). The magnetic coupling mechanism includes gear portions (3c) formed on the shafts (3), a ring gear (4) rotatably supported in the housing (2) on the outer periphery of the axial ends of both shafts (3), and a carrier (5) rotatably supported coaxially with the ring gear (4) in the outside of the housing (2). When the carrier (5) is driven, the ring gear (4) rotates because of the magnetic action between magnet portions (4b, 5b), and the shafts (3) rotates because of the meshing of the gear portions (3c, 4a). Since the inside of the housing can be sealed, airtightness can be assured.

### TECHNICAL FIELD

The present invention relates to a kneading machine.

### BACKGROUND ART

As the machines which knead a raw material such as powder, granules or liquid, kneading machines of the so called two-shaft continuous type as described in Patent Document 1 are known.

This type of kneading machines are so constituted by axially supporting a pair of shafts in parallel in a housing and attaching a number of paddles (agitating blades) and screws to both rotation shafts.

In the housing, a supply port is formed in one end in the longitudinal direction, and a discharge port is formed in the other end thereof. With the rotation of both shafts, the raw material supplied to the housing through the supply port is agitated by the paddles and transferred to the discharge port by the screws, and finally, a kneaded product is discharged from the discharge port.

In case of a raw material which likely leaks, such as a resin solution, is selected, since a high airtightness is required in the housing, shaft seals are used for the shafts.

In case of two-shaft continuous type kneading machines, mechanical seals are generally used as the shaft seals for high vacuum.

### PRIOR ART DOCUMENTS

### Patent Documents

Patent Document 1: JP 3744873 B

### SUMMARY OF THE INVENTION

### Problems to be Solved by the Invention

However, usually, since mechanical seals have complicated structures, they are costly. In addition, employing mechanical seals makes the whole size of the kneading machine large. Especially in case of a two-shaft kneading machine of self-cleaning type, since the distance between the shafts is restricted within a prescribed range, the type of the seals is limited and a special design is needed in order to keep a high airtightness, so that the cost is further increased.

Further, in case of using mechanical seals, since the administration of the sealant controlling the inner pressure is necessary, the maintenance of the supply circulation apparatus of the sealant is also troublesome and costly.

Accordingly, a problem to be solved by the present invention is to assure the airtightness in the housing of a two-shaft continuous kneading machine by a simple means without using a mechanical seal.

### Means for Solving the Problem

To solve the above-described problem, with the kneading machine of the present invention, shafts can be rotated in the state sealed within a housing by forming a magnetic coupling between the mechanism in the housing including the shafts and a carrier which is driven to rotate and is arranged outside the housing.

More particularly, the following constitution is employed for the kneading machine of the present invention. That is, the kneading machine of the present invention comprises a housing in which a supply port is formed in one end in the longitudinal direction thereof and a discharge port is formed in the other end thereof; a pair of shafts rotatably supported in parallel in the longitudinal direction of the housing and sealed in the housing, the shafts having a plurality of paddles and screws aligned in the axial direction on the outer peripheries thereof; and a magnetic coupling mechanism which rotates both the shafts; wherein the magnetic coupling mechanism comprises gear portions provided on the respective shafts so as to be spaced apart from each other in the axial direction; a cylindrical ring gear rotatably supported in the housing so as to cover the axial ends of both the shaft, the ring gear having a gear portion in the inner periphery thereof which meshes with the gear portions of both shafts, and having a magnet portion on the outer periphery thereof; and a cylindrical carrier rotatably supported outside the housing and coaxially with the ring gear, the carrier having a magnetic portion in the inner surface thereof.

### Effects of the Invention

With the constitution of the kneading machine as described above, upon driving the carrier outside the housing, the ring gear is rotated by the magnetic force between the opposing magnet portions, and then the shafts are rotated by the meshing between the gear portions.

Since a magnetic coupling mechanism is formed between inside and outside of the housing so as to enable the shafts to rotate in the state tightly enclosed within the housing, airtightness is assured by a simple means.

### BRIEF DESCRIPTION OF THE DRAWINGS

FIG. 1(a) is a longitudinal sectional view of the kneading machine; and FIG. 1(b) is a sectional view taken along the arrows in FIG. 1(a).

FIG. 2 is a side view of a power transmission mechanism.

FIG. 3 is an enlarged longitudinal sectional view of a portion of the kneading machine.

FIG. 4 is a sectional view taken along the arrows in FIG. 3.

### MODE FOR CARRYING OUT THE INVENTION

An embodiment of the present invention is now described referring to the drawings.

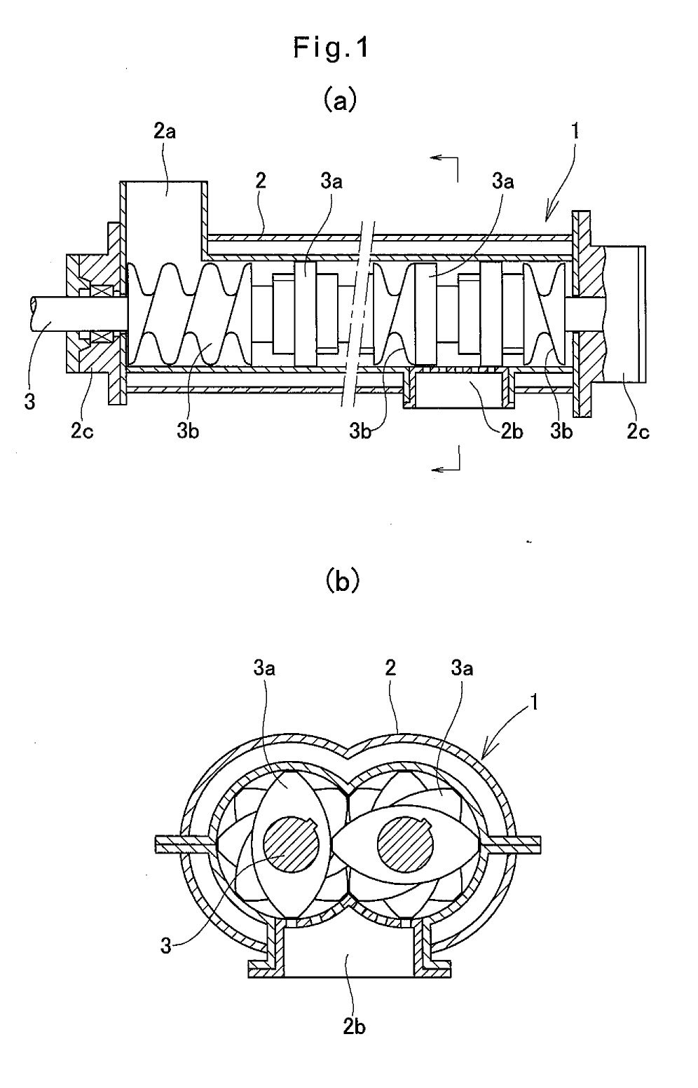

The kneading machine 1 of an embodiment shown in FIG. 1 is suitably used for kneading a raw material which easily leaks and for which airtightness is required, such as a resin polymerized in a solvent or a resin solution required for removing monomers.

As shown, the kneading machine 1 includes a housing 2 and a pair of shafts 3 sealed in the housing 2.

The kneading machine 1 further includes a magnetic coupling mechanism for rotating the shafts 3.

As shown in FIG. 1, in the dual cylindrical housing 2, a supply port 2a of a raw material is formed in the upper portion in one end of the outer peripheral surface thereof, and a discharge port 2b of a kneaded product is formed in the lower portion in the other end of the outer peripheral surface.

Further, on the longitudinal ends of the housing 2, bearing boxes 2c in which bearings are incorporated are mounted.

The rotatable shafts 3 are arranged within the respective cylinders of the dual cylindrical housing 2 along the longitudinal direction, and arranged in parallel with each other.

Each rotatable shaft 3 is rotatably supported on bearings 2d in the bearing boxes 2c at both ends of the housing 2, and a plurality of paddles 3a and screws 3b aligned along the axial direction are attached to the outer periphery thereof. Oil seals 2e are provided between each of the bearing boxes 2c and the respective shafts 3.

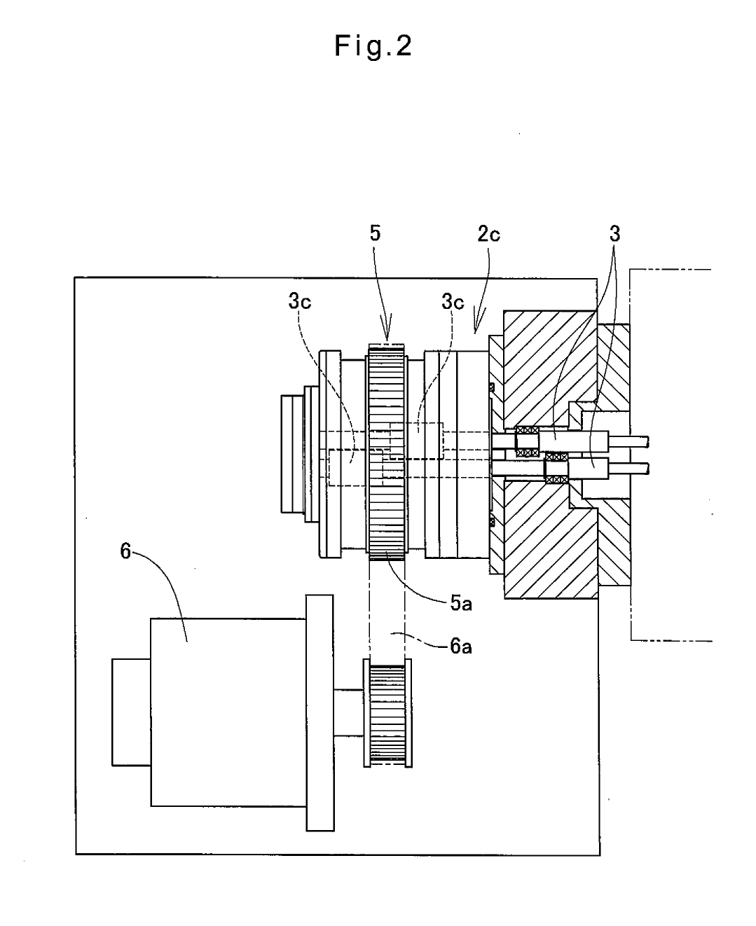

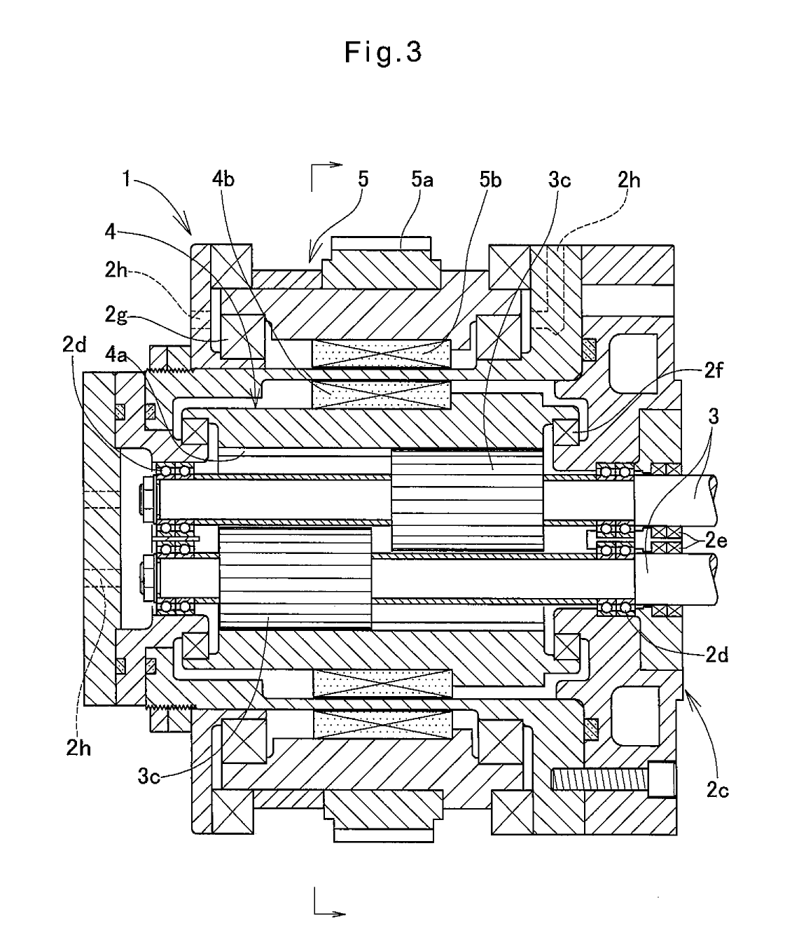

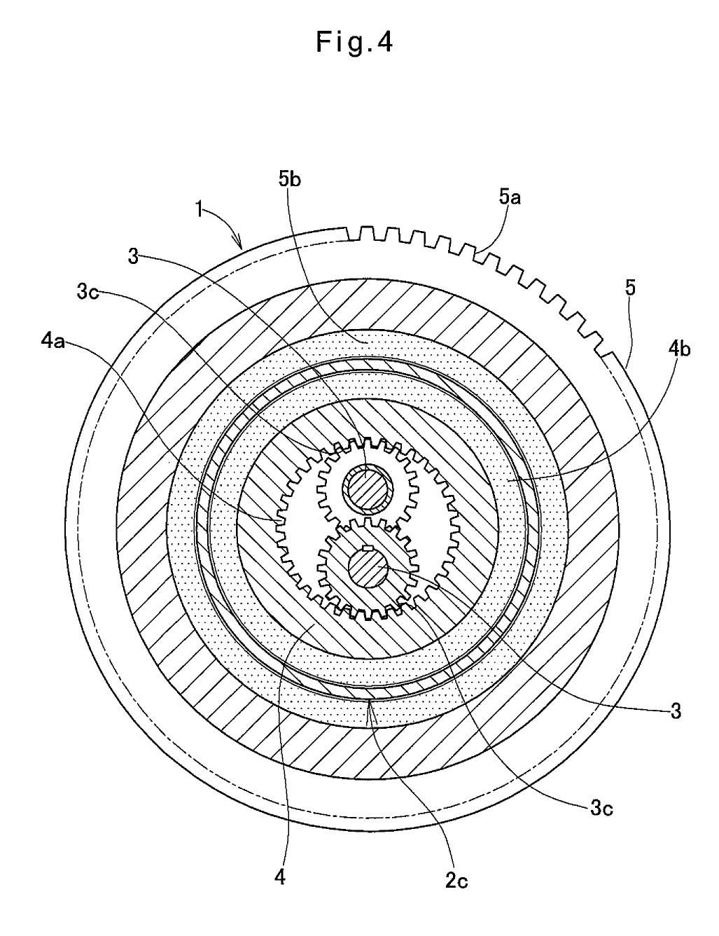

As shown in FIGS. 2 to 4, on the axial ends of both shafts 3 enclosed in one of the bearing boxes 2c of the housing 2, gear portions 3c are formed, respectively. Both gear portions 3c are arranged at an interval in the axial direction of the shafts 3 such that they do not interfere with each other.

In this bearing box, a cylindrical ring gear 4 is rotatably supported so as to surround the axial ends of the shafts 3. An oil seal 2f is provided between the bearing box 2c and the ring gear 4.

The ring gear 4 has a gear portion 4a on the inner surface thereof which meshes with the gear portions 3c of the respective shafts 3. A permanent magnet is fixed on the inner periphery of the ring gear 4 to form a cylindrical magnet portion 4b.

Further, outside the bearing box 2c, a cylindrical carrier 5 coaxial with the ring gear 4 is rotatably supported.

The carrier 5 has a gear portion 5a on the outer periphery thereof, and a permanent magnet is fixed on the inner periphery of the carrier 5 to form a cylindrical magnet portion 5b. An oil seal 2g is provided between the bearing box 2c and the carrier 5.

As shown in FIG. 2. a timing belt 6a is engaged with the carrier 5 and a motor 6, so that rotation is transferred from the motor 6 to the carrier 5.

In the bearing box 2c, a supply/discharge port 2h for grease and a channel for cooling water are appropriately formed.

With the constitution of the kneading machine of the present embodiment described above, upon rotating the carrier 5 outside the housing 2, the ring gear 4 inside the housing 2 starts to rotate together with the carrier 5 due to the magnetic force between the magnet portion 5b and the magnet portion 4b.

When the ring gear 4 rotates, both shafts 3 start to rotate in the same direction due to the meshing between the gear portion 4a and the gear portions 3c.

Thus, the magnetic coupling mechanism is constituted by the gear portions 3c of the shafts 3 and the ring gear 4, which are located inside the bearing box 2c, and the carrier 5 located outside the bearing box 2c via a wall.

Upon supplying a raw material from the supply port 2a of the housing 2, the raw material is agitated by the paddles 3a rotating integrally with the shafts 3 and is made into a kneaded product. The kneaded product is transferred in the housing 2 to the discharge port 2b by the screws 3b rotating integrally with the shafts 3, and is finally discharged from the discharge port 2b.

Since the shafts 3 are sealed in the housing 2 and since the power is transmitted via a wall using the magnetic coupling mechanism, airtightness is assured by a simple constitution.

Because of the simple constitution, the production cost is reduced and the overall size of the kneading machine 1 is made small when compared with the cases where a mechanical seal or the like is used for assuring airtightness.

Since the size of the machine can be made small, even in cases where the distance between the shafts is restricted within a prescribed range, a special design is not required unlike the cases where a mechanical seal is employed.

Since no management of a sealant is necessary unlike the cases where the mechanical seal is employed, the labor and cost for the maintenance can also be reduced.

### DESCRIPTION OF SYMBOLS

1 kneading machine of an embodiment

2 housing

2a supply port

2b discharge port

2c bearing box

2d bearing

2e, 2f, 2g oil seal

2g supply/discharge port for grease

3 shafts

3a paddles

3b screws

3c gear portions

4 ring gear

4a gear portion

4b magnet portion

5 carrier

5a gear portion

5b magnet portion

6 motor

6a timing belt

1. A kneading machine comprising:
a housing (2) in which a supply port (2a) is formed in one of first and second ends with respect to a longitudinal direction of the housing and a discharge port (2b) is formed in the other of the first and second ends;
a pair of shafts (3) rotatably supported in parallel in the longitudinal direction of said housing and sealed in said housing (2), said shafts having a plurality of paddles (3a) and screws (3b) aligned in axial directions of the respective shafts, on outer peripheries thereof; and
a magnetic coupling mechanism which rotates both said shafts (3);
wherein said magnetic coupling mechanism comprises:
gear portions (3c) provided on end portions of the respective shafts (3) so as to be spaced apart from each other in the axial directions;
a cylindrical ring gear (4) rotatably supported in said housing (2) so as to cover the end portions of both said shaft (3), said ring gear (4) having a gear portion (4a) on an inner periphery thereof which meshes with said gear portions (3c) of both said shafts (3), and having a magnet portion (4b) on an outer periphery thereof; and
a cylindrical carrier (5) rotatably supported outside said housing (2) and coaxially with said ring gear (4), said carrier (5) having a magnetic portion (5b) on an inner periphery thereof.
